(19) United States
(12) Patent Application Publication
(10) Pub. No.: US 2013/0057183 A1
(43) Pub. Date: Mar. 7, 2013

(54) HYDRAULIC ELECTRICITY GENERATOR AND SEPARATION TYPE ELECTRIC FLUID PUMP DRIVEN BY THE SAME

(71) Applicant: Tai-Her YANG, Dzan-Hwa (TW)

(72) Inventor: Tai-Her YANG, Dzan-Hwa (TW)

(21) Appl. No.: 13/226,645

(22) Filed: Sep. 7, 2011

(51) Int. Cl. H02P 27/00

(52) U.S. Cl. 318/140

(57) ABSTRACT

The present invention relates to a hydraulic electricity generator and separation type electric fluid pump driven by the same, wherein an external fluid in a specific space is adopted as a driving power source for driving a blade set to convert the fluid kinetic energy into rotary kinetic energy to drive a generator, and the electric power produced by the generator is transmitted through a conductive wire for transmitting electric power with a linear transmission means, thereby driving an electric fluid pump device including an electric fluid pump or electric fan and installed in the specific space, the application thereof is for example converting the external fluid kinetic energy into indoor airflows.

### BACKGROUND OF THE INVENTION

(a) Field of the Invention

The present invention relates to a hydraulic electricity generator and separation type electric fluid pump driven by the same, wherein an external fluid in a specific space is adopted as a driving power source for driving a blade set to convert the fluid kinetic energy into rotary kinetic energy to drive a generator, and the electric power produced by the generator is transmitted through a conductive wire for transmitting electric power with a linear transmission means, thereby driving an electric fluid pump device including an electric fluid pump or electric fan and installed in the specific space, the application thereof is for example converting the external fluid kinetic energy into indoor airflows.

(b) Description of the Prior Art

For a drive motor of conventional fluid pump device such as an electric fluid pump or electric fan, one disadvantage thereof is that the electric power used for driving often consumes the electric power of public electricity; and for the conventional means of utilizing flow force to drive a blade set to produce rotary kinetic energy to directly drive a fluid pump, the construction and installation thereof are relatively harder due to the limitation of transmission distance and space.

### SUMMARY OF THE INVENTION

The hydraulic electricity generator and separation type electric fluid pump driven by the same provided by the present invention adopts the kinetic energy of an external fluid in a specific space to drive a generator, and the electric power generated by the generator is transmitted for driving a fluid pump device having a drive motor and installed in the specific space.

### BRIEF DESCRIPTION OF THE DRAWINGS

FIG. 1 is a schematic view showing the main structural block of the Hydraulic electricity generator and separation type electric fluid pump driven by the same of the present invention.

FIG. 2 is a schematic view showing the structural block of an embodiment, in which an electronic control device (107) is further installed to FIG. 1.

FIG. 3 is a schematic view showing the structural block of an embodiment, in which the electronic control device (107) and a electric charging/discharging device (108) are further installed to FIG. 1,

FIG. 4 is a schematic view showing the structural block of an embodiment, in which a front transmission (103) is further installed to FIG. 1.

FIG. 5 is a schematic view showing the structural block of an embodiment, in which the front transmission (103) is further installed to FIG. 2.

FIG. 6 is a schematic view showing the structural block of an embodiment, in which the front transmission (103) is further installed to FIG. 3.

FIG. 7 is a schematic view showing the structural block of an embodiment, in which a rear transmission (106) is further installed to FIG. 1.

FIG. 8 is a schematic view showing the structural block of an embodiment, in which the rear transmission (106) is further installed to FIG. 2.

FIG. 9 is a schematic view showing the structural block of an embodiment, in which the rear transmission (106) is further installed to FIG. 3.

FIG. 10 is a schematic view showing the structural block of an embodiment, in which the front transmission (103) and the rear transmission (106) are further installed to FIG. 1.

FIG. 11 is a schematic view showing the structural block of an embodiment, in which the front transmission (103) and the rear transmission (106) are further installed to FIG. 2.

FIG. 12 is a schematic view showing the structural block of an embodiment, in which the front transmission (103) and the rear transmission (106) are further installed to FIG. 3.

### DESCRIPTION OF MAIN COMPONENT SYMBOLS

101: flow-driven input device
102: Generator
103: Front transmission
104: Motor
105: Fluid pump device
106: Rear transmission
107: Electronic control device
108: Electric charging/discharging device

### DETAILED DESCRIPTION OF THE PREFERRED EMBODIMENTS

For a drive motor of conventional fluid pump device such as an electric fluid pump or electric fan, one disadvantage thereof is that the electric power used for driving often consumes the electric power of public electricity; and for the conventional means of utilizing flow force to drive a blade set to produce rotary kinetic energy to directly drive a fluid pump, the construction and installation thereof are relatively harder due to the limitation of transmission distance and space.

The present invention relates to a hydraulic electricity generator and separation type electric fluid pump driven by the same, wherein an external fluid in a specific space is adopted as a driving power source for driving a blade set to convert the fluid kinetic energy into rotary kinetic energy to drive a generator, and the electric power produced by the generator is transmitted through a conductive wire for transmitting electric power with a linear transmission means, thereby driving an electric fluid pump device including an electric fluid pump or electric fan and installed in the specific space, the application thereof is for example converting the external fluid kinetic energy into indoor airflows.

The hydraulic electricity generator and separation type electric fluid pump driven by the same provided by the present invention adopts the kinetic energy of an external fluid in a specific space to drive a generator, and the electric power generated by the generator is transmitted for driving a fluid pump device having a drive motor and installed in the specific space; the main components including:

flow-driven input device (101): through the airflow or the fluid at outdoor to drive the blade set thereof generating the rotary kinetic energy, so as to directly drive a generator (102), or further installed with a transmission unit to drive the generator (102) after variable speed transmission;

generator (102): constituted by the AC or DC generator (102), which is driven by the rotary kinetic energy of the flow-driven input device (101) to produce and output electric energy for driving a motor (104) through the conductive wire;

motor (104): constituted by the AC or DC motor (104), which is driven by the electric energy of the generator (102) for performing rotation driving, so as to produce and output the rotary mechanical energy to directly drive a fluid pump device (105), or further installed with a transmission unit to drive the fluid pump device (105) after variable speed transmission;
fluid pump device (105): constituted by a fan blade set or pneumatic pump for pumping airflow or a propeller or fluid pump for pumping fluid;

the relationship between the input rotary speed of the generator (102) and the motor (104) includes: 1) directly matching according to the features of voltage, current, rotary speed and torque of the both, or 2) through the electronic control device installed between the power output terminal of the generator (102) and the power input terminal of the motor (104) to control the generated power of the generator and/or control the input power of the motor (104), therefore to control the rotary speed of the motor.

In the hydraulic electricity generator and separation type electric fluid pump driven by the same, the electric power generation and operational features of the generator (102) to the motor (104) includes one or more of the followings, including:

1) the electric power of the DC generator directly drives the DC motor; and/or

2) the electric power of the DC generator drives the AC motor through an inverter; and/or

3) the electric power of the AC generator directly drives the AC motor; and/or

4) the electric power of the AC generator is rectified then drives the DC motor;

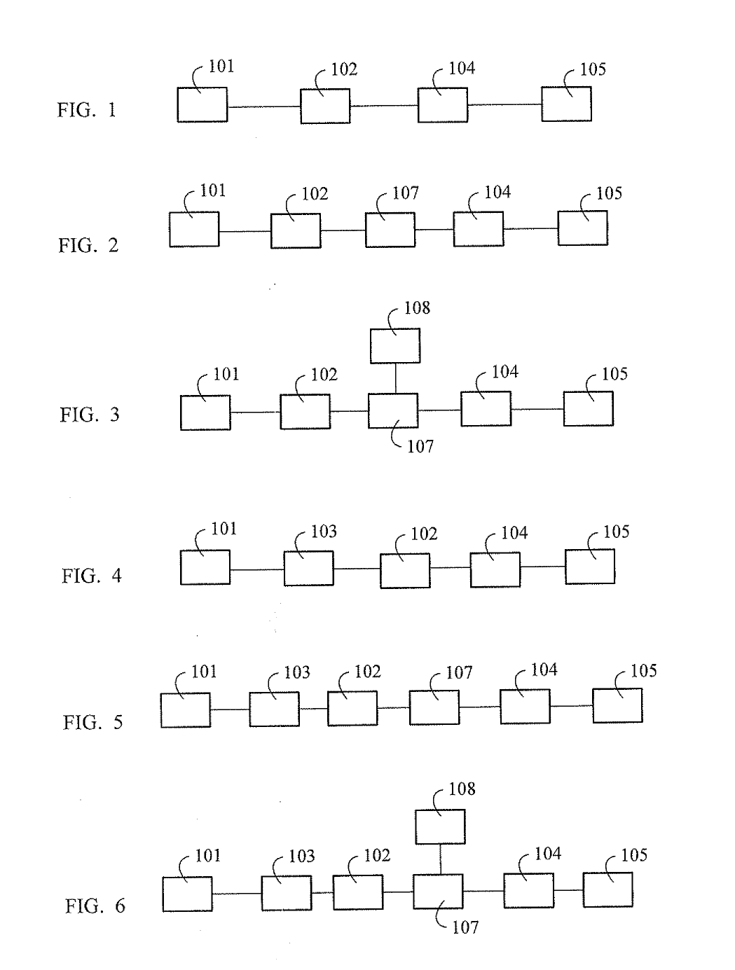

FIG. 1 is a schematic view showing the main structural block of the hydraulic electricity generator and separation type electric fluid pump driven by the same of the present invention; as shown in FIG. 1, the main components including:

flow-driven input device (101): through the air flow or the fluid outside a specific space to drive the blade set thereof generating the rotary kinetic energy, so as to directly drive a generator (102), or further installed with a transmission unit to drive the generator (102) after variable speed transmission;

generator (102): constituted by the AC or DC generator (102), which is driven by the rotary kinetic energy of the flow-driven input device (101) to produce and output electric energy for driving a motor (104) in a specific space through the conductive wire;

motor (104): constituted by the AC or DC motor (104), which is driven by the electric energy of the generator (102) for performing asynchronous rotation driving, so as to produce and output the rotary mechanical energy to directly drive a fluid pump device (105), or further installed with a transmission unit to drive the fluid pump device (105) after variable speed transmission;

fluid pump device (105): constituted by a fan blade set or pneumatic pump for pumping airflow or a propeller or fluid pump for pumping fluid;

the relationship between the input rotary speed of the generator (102) and the motor (104) includes: 1) directly matching according to the features of voltage, current, rotary speed and torque of the both, or 2) through the electronic control device installed between the power output terminal of the generator (102) and the power input terminal of the motor (104) to control the generated power of the generator and/or control the input power of the motor (104), therefore to control the rotary speed of the motor.

For the hydraulic electricity generator and separation type electric fluid pump driven by the same, the electronic control device (107) is further installed between the generator (102) and the motor (104).

FIG. 2 is a schematic view showing the structural block of an embodiment, in which the electronic control device (107) is further installed to FIG. 1; in which:

the electronic control device (107) is constituted by electromechanical components and/or solid state electronic components and/or the microprocessor with related operating softwares, and provided to regulate the voltage and current transmitted to the motor (104) from the generator (102), and/or to control the voltage and current input to the motor (104), so as to control the rotary speed, torque and rotary direction of the motor (104).

For the hydraulic electricity generator and separation type electric fluid pump driven by the same, the electronic control device (107) and the electric charging/discharging device (108) are further installed between the generator (102) and the motor (104).

FIG. 3 is a schematic view showing the structural block of an embodiment, in which the electronic control device (107) and the electric charging/discharging device (108) are further installed to FIG. 1; in which:

the electric charging/discharging device (108) is constituted by the rechargeable battery, or the capacitor, or ultra capacitor; and the electric charging/discharging device (108) is installed with an output interface, such as the plug, or the socket, or the wire connector, for receiving the external current charging the electric charging/discharging device (108), or for the electric charging/discharging device (108) supplying power externally; and

the electronic control device (107) is constituted by electromechanical components and/or solid state electronic components and/or the microprocessor with related operating softwares, for controlling the power operations of the generator (102), the motor (104) and the electric charging/discharging device (108), which includes one or more of the following operational functions:

1) regulating the voltage and current transmitted to the motor (104) from the generator (102), and/or controlling the voltage and current input to the motor (104), so as to control the rotary speed, torque and rotary direction of the motor (104);

2) controlling the voltage, current, rotary speed, torque and rotary direction of the motor (104) which is driven by the electric power from the electric charging/discharging device (108);

3) controlling the voltage, current, rotary speed, torque and rotary direction of the motor (104) which is jointly driven by the generator (102) and the electric charging/discharging device (108);

4) controlling the rotary direction relationship between the generator and the motor;

5) controlling the voltage, current, rotary speed, torque and rotary direction of the motor (104) which is driven by the generator (102), and simultaneously controlling the charging timing, charging voltage, charging current and charging cut-off time for the generator (102) to the electric charging/discharging device (108);

6) controlling the charging voltage, charging current, charging start time and charging cut-off time for the generator (102) to the electric charging/discharging device (108); and

7) controlling the charging start time, charging voltage, charging current and charging cut-off time for the power regenerated by the motor (104) to the electric charging/discharging device (108).

For the hydraulic electricity generator and separation type electric fluid pump driven by the same, the front transmission (103) is further installed between the flow-driven input device (101) and the generator (102), in which the front transmission (103) is a rotary transmission with constant or variable speed ratio, which is constituted by the gear, or the sprocket and chain, or the pulley and belt, or the connecting rod.

FIG. 4 is a schematic view showing the structural block of an embodiment, in which the front transmission (103) is further installed to FIG. 1.

FIG. 5 is a schematic view showing the structural block of an embodiment, in which the front transmission (103) is further installed to FIG. 2.

FIG. 6 is a schematic view showing the structural block of an embodiment, in which the front transmission (103) is further installed to FIG. 3.

For the hydraulic electricity generator and separation type electric fluid pump driven by the same, the rear transmission (106) is further installed between the motor (104) and the fluid pump device (105), in which the rear transmission (106) is a rotary transmission with constant or variable speed ratio, which is constituted by the gear, or the sprocket and chain, or the pulley and belt, or the connecting rod.

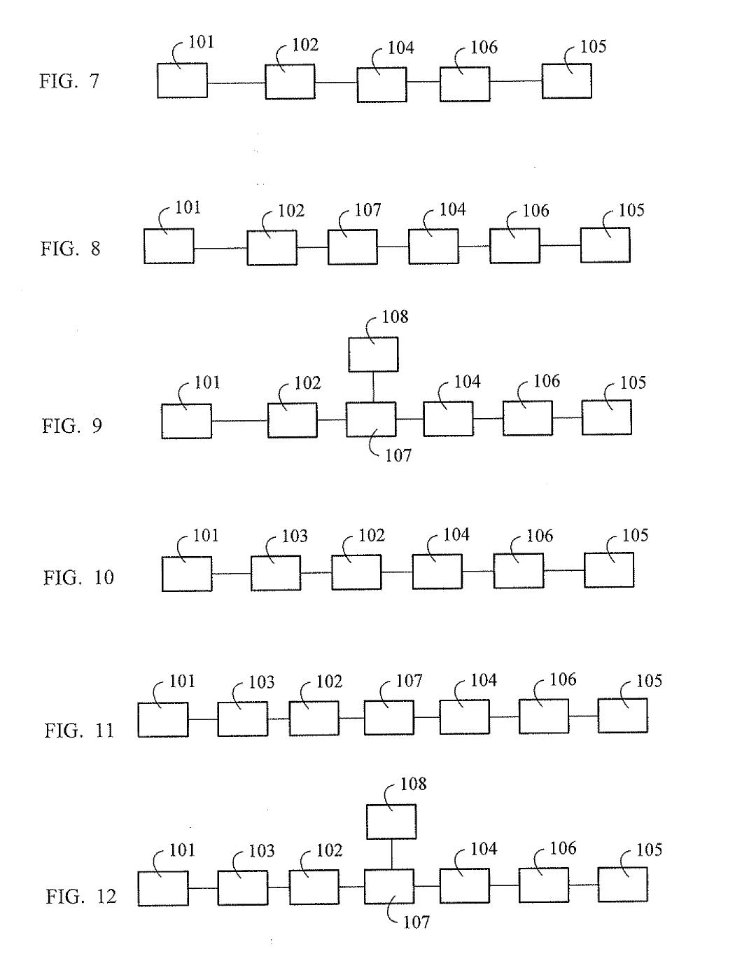

FIG. 7 is a schematic view showing the structural block of an embodiment, in which the rear transmission (106) is further installed to FIG. 1.

FIG. 8 is a schematic view showing the structural block of an embodiment, in which the rear transmission (106) is further installed to FIG. 2.

FIG. 9 is a schematic view showing the structural block of an embodiment, in which the rear transmission (106) is further installed to FIG. 3.

For the hydraulic electricity generator and separation type electric fluid pump driven by the same, the front transmission (103) is further installed between the flow-driven input device (101) and the generator (102), and the rear transmission (106) is further installed between the motor (104) and the fluid pump device (105), in which:

the front transmission (103) is a rotary transmission with constant or variable speed ratio, which is constituted by the gear, or the sprocket and chain, or the pulley and belt, or the connecting rod; and

the rear transmission (106) is a rotary transmission with constant or variable speed ratio, which is constituted by the gear, or the sprocket and chain, or the pulley and belt, or the connecting rod.

FIG. 10 is a schematic view showing the structural block of an embodiment, in which the front transmission (103) and the rear transmission (106) are further installed to FIG. 1.

FIG. 11 is a schematic view showing the structural block of an embodiment, in which the front transmission (103) and the rear transmission (106) are further installed to FIG. 2.

FIG. 12 is a schematic view showing the structural block of an embodiment, in which the front transmission (103) and the rear transmission (106) are further installed to FIG. 3.

1. A hydraulic electricity generator and separation type electric fluid pump driven by the same, wherein an external fluid in a specific space is adopted as a driving power source for driving a blade set to convert the fluid kinetic energy into rotary kinetic energy to drive a generator, and the electric power produced by the generator is transmitted through a conductive wire for transmitting electric power with a linear transmission means, thereby driving an electric fluid pump device including an electric fluid pump or electric fan and installed in the specific space, the application thereof is for example converting the external fluid kinetic energy into indoor airflows, wherein the main components including:
flow-driven input device (101): through the airflow or the fluid at outdoor to drive the blade set thereof generating the rotary kinetic energy, so as to directly drive a generator (102), or further installed with a transmission unit to drive the generator (102) after variable speed transmission;
generator (102): constituted by the AC or DC generator (102), which is driven by the rotary kinetic energy of the flow-driven input device (101) to produce and output electric energy for driving a motor (104) through the conductive wire;
motor (104): constituted by the AC or DC motor (104), which is driven by the electric energy of the generator (102) for performing rotation driving, so as to produce and output the rotary mechanical energy to directly drive a fluid pump device (105), or further installed with a transmission unit to drive the fluid pump device (105) after variable speed transmission;
fluid pump device (105): constituted by a fan blade set or pneumatic pump for pumping airflow or a propeller or fluid pump for pumping fluid;
the relationship between the input rotary speed of the generator (102) and the motor (104) includes: 1) directly matching according to the features of voltage, current, rotary speed and torque of the both, or 2) through the electronic control device installed between the power output terminal of the generator (102) and the power input terminal of the motor (104) to control the generated power of the generator and/or control the input power of the motor (104), therefore to control the rotary speed of the motor;
In the hydraulic electricity generator and separation type electric fluid pump driven by the same, the electric power generation and operational features of the generator (102) to the motor (104) includes one or more of the followings, including:
1) the electric power of the DC generator directly drives the DC motor; and/or
2) the electric power of the DC generator drives the AC motor through an inverter; and/or
3) the electric power of the AC generator directly drives the AC motor; and/or
4) the electric power of the AC generator is rectified then drives the DC motor.

2. A hydraulic electricity generator and separation type electric fluid pump driven by the same as claimed in claim 1, wherein the main components including:
flow-driven input device (101): through the air flow or the fluid outside a specific space to drive the blade set thereof generating the rotary kinetic energy, so as to directly drive a generator (102), or further installed with a transmission unit to drive the generator (102) after variable speed transmission;
generator (102): constituted by the AC or DC generator (102), which is driven by the rotary kinetic energy of the flow-driven input device (101) to produce and output electric energy for driving a motor (104) in a specific space through the conductive wire;
motor (104): constituted by the AC or DC motor (104), which is driven by the electric energy of the generator (102) for performing asynchronous rotation driving, so as to produce and output the rotary mechanical energy to directly drive a fluid pump device (105), or further installed with a transmission unit to drive the fluid pump device (105) after variable speed transmission;
fluid pump device (105): constituted by a fan blade set or pneumatic pump for pumping airflow or a propeller or fluid pump for pumping fluid;
the relationship between the input rotary speed of the generator (102) and the motor (104) includes: 1) directly matching according to the features of voltage, current, rotary speed and torque of the both, or 2) through the electronic control device installed between the power output terminal of the generator (102) and the power input terminal of the motor (104) to control the generated power of the generator and/or control the input power of the motor (104), therefore to control the rotary speed of the motor.

3. A hydraulic electricity generator and separation type electric fluid pump driven by the same as claimed in claim 1 or 2, wherein the electronic control device (107) is further installed between the generator (102) and the motor (104), in which:
the electronic control device (107) is constituted by electromechanical components and/or solid state electronic components and/or the microprocessor with related operating softwares, and provided to regulate the voltage and current transmitted to the motor (104) from the generator (102), and/or to control the voltage and current input to the motor (104), so as to control the rotary speed, torque and rotary direction of the motor (104).

4. A hydraulic electricity generator and separation type electric fluid pump driven by the same as claimed in claim 1 or 2, wherein the electronic control device (107) and the electric charging/discharging device (108) are further installed between the generator (102) and the motor (104), in which:
the electric charging/discharging device (108) is constituted by the rechargeable battery, or the capacitor, or ultra capacitor; and the electric charging/discharging device (108) is installed with an output interface, such as the plug, or the socket, or the wire connector, for receiving the external current charging the electric charging/discharging device (108), or for the electric charging/discharging device (108) supplying power externally; and
the electronic control device (107) is constituted by electromechanical components and/or solid state electronic components and/or the microprocessor with related operating softwares, for controlling the power operations of the generator (102), the motor (104) and the electric charging/discharging device (108), which includes one or more of the following operational functions:
1) regulating the voltage and current transmitted to the motor (104) from the generator (102), and/or controlling the voltage and current input to the motor (104), so as to control the rotary speed, torque and rotary direction of the motor (104);
2) controlling the voltage, current, rotary speed, torque and rotary direction of the motor (104) which is driven by the electric power from the electric charging/discharging device (108);
3) controlling the voltage, current, rotary speed, torque and rotary direction of the motor (104) which is jointly driven by the generator (102) and the electric charging/discharging device (108);
4) controlling the rotary direction relationship between the generator and the motor;
5) controlling the voltage, current, rotary speed, torque and rotary direction of the motor (104) which is driven by the generator (102), and simultaneously controlling the charging timing, charging voltage, charging current and charging cut-off time for the generator (102) to the electric charging/discharging device (108);
6) controlling the charging voltage, charging current, charging start time and charging cut-off time for the generator (102) to the electric charging/discharging device (108); and
7) controlling the charging start time, charging voltage, charging current and charging cut-off time for the power regenerated by the motor (104) to the electric charging/discharging device (108).

5. A hydraulic electricity generator and separation type electric fluid pump driven by the same as claimed in claim 1 or 2, wherein the front transmission (103) is further installed between the flow-driven input device (101) and the generator (102), in which the front transmission (103) is a rotary transmission with constant or variable speed ratio, which is constituted by the gear, or the sprocket and chain, or the pulley and belt, or the connecting rod.

6. A hydraulic electricity generator and separation type electric fluid pump driven by the same as claimed in claim 1 or 2, wherein the rear transmission (106) is further installed between the motor (104) and the fluid pump device (105), in which the rear transmission (106) is a rotary transmission with constant or variable speed ratio, which is constituted by the gear, or the sprocket and chain, or the pulley and belt, or the connecting rod.

7. A hydraulic electricity generator and separation type electric fluid pump driven by the same as claimed in claim 1 or 2, wherein the front transmission (103) is further installed between the flow-driven input device (101) and the generator (102), and the rear transmission (106) is further installed between the motor (104) and the fluid pump device (105), in which:
the front transmission (103) is a rotary transmission with constant or variable speed ratio, which is constituted by the gear, or the sprocket and chain, or the pulley and belt, or the connecting rod; and
the rear transmission (106) is a rotary transmission with constant or variable speed ratio, which is constituted by the gear, or the sprocket and chain, or the pulley and belt, or the connecting rod.
